(19) United States
(12) Patent Application Publication
(10) Pub. No.: US 2007/0140086 A1
(43) Pub. Date: Jun. 21, 2007

(54) Method and apparatus of parameters optimization in optical disc writing

(76) Inventors: Jing Tao, Shanghai (CN); Fulong Tang, Shanghai (CN); Dianyong Chen, Shanghai (CN); Gerardus Rudolph Langereis, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/580,054

(22) PCT Filed: Nov. 22, 2004
(86) PCT No.: PCT/IB04/52495

§ 371 Date: May 22, 2006

(30) Foreign Application Priority Data
Nov. 26, 2003 (CN) 200310120724.1

(51) Int. Cl. G11B 7/0045

(52) U.S. Cl. 369/59.11

(57) ABSTRACT

A method for optimizing the optical disc writing parameters, comprising the steps: acquiring the variable of a mark runlength; determining a modulation amount of the writing parameters based on a relationship between the variable of the mark runlength and the modulation amount of the writing parameters; and modulating the writing parameters. The method is applicable to multifarious optical disc systems, it can adopt multifarious strategies for the writing process, it can optimize the power or the starting time and the stopping time of a plurality of laser pulses, thereby it can get the aim of optimizing the mark runlength.

### TECHNICAL FIELD

The present invention relates to a method for optimizing optical disc writing parameters, particularly to the method and apparatus for simultaneously optimizing a plurality of optical disc writing parameters.

### BACKGROUND OF THE INVENTION

Nowadays, optical disc system has become the ideal carrier for multi-media audiovisual information and a great amount of data owing to its relatively low cost and large capacity. The current optical discs includes: CD (compact disc) using EFM (Eight to Fourteen Modulation) encoding rule; DVD using EFM+ encoding rule; BD (Blu-Ray Disc) using 17PP encoding rule; and some other unpopular optical discs. Each of said kinds of optical discs could be classified into read-only optical disc, once recordable optical disc and rewritable optical disc.

As for once recordable optical disc and rewritable optical disc, data is represented by the marks written by recording laser and the spaces between the marks. Since they have different reflectance to the focused reading laser, high frequency modulated signals are generated. Analog high frequency signals are sent to a binary signal slicer after AC coupling and compared with the slice level to convert into a binary data, thus the mark level and space level corresponding to the marks and spaces on the optical disc respectively are obtained. Then, after being coupled to a clock signal, the runlength of each mark and space could be obtained so as to restore the recorded original data.

The restoration of the original data depends on the mark runlength and space runlength obtained by slicing, but it is ultimately determined by the physical length of the marks by writing. The physical length of spaces are decided by the physical lengths of the two marks adjacent thereto, so the accuracy of the physical length of the marks by writing decides the deviation amount of the runlength of the marks and spaces by reading and thereby decides the quality of the writing of a optical disc.

In order to write a optical disc accurately, many different writing strategies have been developed according to different types of optical discs, such as square wave shape laser writing strategy suitable for once recordable CD-R optical discs; “dog-bone” wave shape writing strategy of higher power suitable for the starting and ending portions of once recordable DVD; “1T writing strategy” suitable for low speed (lower than the speed of 10× speed) CD-RW; “2T writing strategy” suitable for high speed phase-change medium optical disc; in addition, there are also other writing strategies suitable for other types of optical discs. Each type of the writing strategies is composed of several different kinds of laser pulses in certain sequence. Generally, different marks are written by different laser pulse sequences, wherein laser pulses of the same kind are represented by the same letter. Each kind of the laser pulses includes two parameters of pulse height (power) and pulse width (decided by the starting time and the ending time). During a practical writing process, if the writing parameters are changed, the quality of data recording will be affected finally.

FIG. 1 shows the laser pulse patterns for writing 3T, 4T and 5T marks at 24× speed in the “2T writing strategy” used for the ultra speed CR-RW system. As shown in FIG. 1, the time of each T in said “2T writing strategy” is equally divided into eight time divisions (herein each time division is 1.206 ns). That is, the writing strategy is a sequence formed of laser pulses with the same widths, and the heights of the laser pulses in each of the time divisions are represented by different letters. The specific laser pulse patterns are as follows:

3T mark

eeewwwww wwwwbbbb bbbcceee

4T mark

eeewwwww wbbbbbbb bbbwwwww wbbbddee

5T mark

eeewwwww wbbbbbbb bbbbbbww wwwwwwb bbbffeee

Wherein, the letter w represents the writing power, e represents erasing power; b represents cooling power; and parameters c, d, f are pulses for precisely adjusting the back edge of 3T, 4T and 5T marks respectively. The specific power could be optimized as desired.

During the writing of an optical disc, in order to obtain the precise physical length of the marks for accurately restoring the original data, the writing parameters have to be optimized, namely, the laser pulse power and/or the starting and ending time in the writing strategy should be optimized.

The conventional methods for optimizing writing parameters concentrate on the optimization of the writing power and erasing power, because the optimum writing and erasing powers under specific writing condition are determined by the matching between the optical disc and the driver.

For once recordable optical disc and low speed rewritable optical disc, the conventional technique only corrects the writing power and the specific technical details have been published as optical disc standards. Before writing an optical disc formally, the driver searches for the optimum writing power according to the OPC (Optimum Power Control) step specified by the optical disc standard. The ATIP (Absolute Time In Pregroove) information on each optical disc includes the optimized initial values of laser pulse parameters related to the writing strategy. The driver uses this optimized initial value as the starting point and performs GAMMA signal measurement according to OPC step to find the optimum writing power. However, the optimum erasing power does not have to be calibrated separately, because the ATIP information includes the ratio between the optimum erasing power and the optimum writing power of this kind of optical discs. As for the detailed OPC step, please refer to the standard in the orange book of the CD-R and CD-RW.

As for optical disc writing of multi-speed, the optical disc driver stores a table for being looked up. Since there are various divergences between the optical discs and the driver, said table for being looked up should contain the writing parameter values of optical discs as much as possible. And the driver having said table could conveniently find the optimized value suitable for the writing parameters of a certain specific optical disc by looking up said table.

However, as for high-speed rewritable optical disc, such as ultra-speed CD-RW, rewritable DVD and rewritable Blu-ray optical discs, the 2T or the more complex writing strategies have to be adopted. There are at least four laser pulse powers or pulse widths to be optimized, while the ATIP code on the discs does not contain the information for optimizing these parameters, and meanwhile, these parameters change with different optics-electrics structure of drivers and the writing environments, so the driver must optimize these parameters by itself. As for an unknown optical disc, it is a great challenge to optimize the writing parameters quickly and flexibly.

The conventional methods for optimizing parameters with respect to high speed rewritable optical disc mainly includes: method for optimizing writing power based on the measurement of data-to-data jitter or data-to-clock jitter put forward by B. Tieke and F. Tang; method for optimizing erasing power based on the Beta measurement put forward by Willem Geurtzen; and method for optimizing erasing power based on the measurement of data-to-data jitter or data-to-clock jitter put forward by F. Tang. But said methods could only optimize the writing power or the erasing power.

However, none of the conventional methods for optimizing writing parameters could be applied to writing various kinds of optical discs (including various kinds of once recordable or rewritable optical discs) and different writing strategies. Especially, there is no method for simultaneously optimizing a plurality of laser pulse parameters with respect to the mark runlength, which could make the mark runlength of each symbol close to the precise mark runlength (e.g., the standard mark runlength specified by the optical disc standard) as much as possible. By standardizing the runlength of each mark, the space runlength will also be standardized so as to obtain smaller length jitter or position jitter of marks and spaces. In this way, low bit error rate could be achieved and accurate original data is obtained finally.

In summary, the conventional methods for optimizing have many defects, so there is the need for a method for optimizing parameters in optical disc writing, which could be applied in all cases, to optimize a plurality of writing parameters simultaneously.

### SUMMARY OF INVENTION

The present invention aims at providing an optical disc writing parameter optimizing method and apparatus, which could obtain precise mark runlength. The present invention further aims at providing a method for optimizing a plurality of optical disc writing parameters simultaneously.

Therefore, the present invention provides an optical disc writing parameters optimizing apparatus,

The present invention further provides a method for optimizing the optical disc writing parameters, comprising the following steps: acquiring variable of the mark runlengths; determining the modulation amounts of the parameters on the basis of the relationship between variable of the mark runlengths and the modulation amounts; and modulating the values of said parameters.

In the present invention, the influence of the parameter modulation amounts on variable of the mark runlengths is determined.

By means of the optimizing method and apparatus provided by the present invention, a plurality of writing parameters could be optimized simultaneously so as to obtain precise mark runlengths.

### BRIEF DESCRIPTION OF THE DRAWINGS

FIG. 1 is the laser pulse patterns of the “2T writing strategy” for writing the 3T, 4T and 5T marks in an ultra-speed CD-RW system;

FIG. 2 is the schematic drawing of obtaining mark runlength in an optical disc writing system;

FIG. 3 is the schematic drawing of re-balance of slice level caused by the variation of high frequency signal;

FIG. 4 is a structural drawing of the optical disc writing parameter optimizing apparatus according to the present invention;

FIG. 5 is the working flow chart according to a preferred embodiment according to the present invention;

FIGS. 6, 7 and 8 are experiments and measurements made for determining the strength (ns/mW) of parameters c, d and f respectively;

FIG. 9 shows the result after once optimizing the runlength deviation of 3T, 4T and 5T marks, and the optimizing target set by the system herein is the standard length of each mark as specified by the standard.

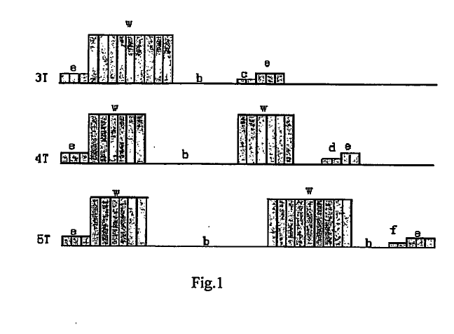

### DETAILED DESCRIPTION OF THE PREFERRED EMBODIMENTS

In order to provide an optimizing method for simultaneously optimizing a plurality of writing parameters, the inventor carefully studied the reason why the parameter variations affect the mark runlengths in optical disc writing. After analyzing, the reason why the conventional optimizing methods are limited to the optimization of a single parameter was found and meanwhile, a new thought came for a new optimizing method.

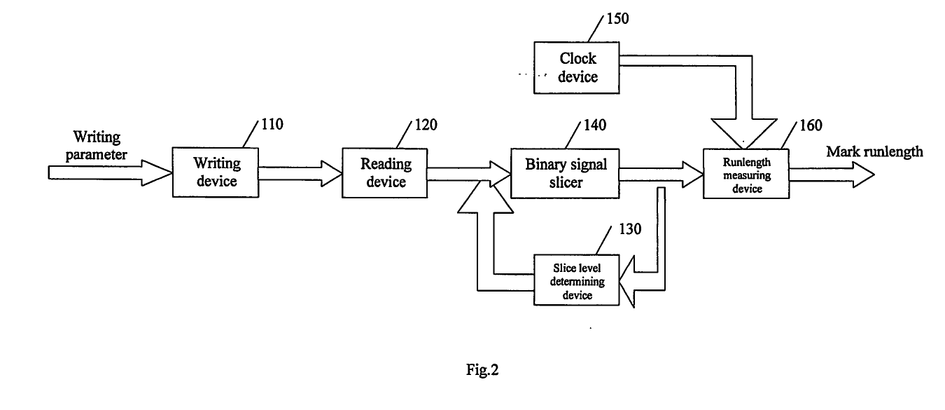

FIG. 2 is the schematic drawing of obtaining mark runlengths in an optical disc writing system, which illustrates the reason why the parameter variations affect the mark runlengths.

During the writing of a once recordable or rewritable optical disc, the writing device 110 writes marks on the optical disc according to the setting of writing parameters, and spaces form between adjacent marks. Marks and spaces have their own physical lengths, which are determined by the writing parameters.

When the marks and spaces on the optical disc are read by the reading device 120, a high frequency modulation signal will be generated which corresponds to the physical mark length and physical space length. The high frequency signal from the reading device 120 is compared with the slice threshold level from the slice level determining device 130 by the binary signal slice device 140, and then converted into a binary data, thus the mark level and space level are obtained. Finally, the runlength measuring device 160 measures the mark level and space level from the binary signal slice device 140 according to the clock signal generated by the internal or external clock device 150, so that the mark and space runlengths are obtained.

The slice threshold level used in the above process is determined by the slice level determining device 130 according to the mark level and space level fed back by the binary signal slice device 140, and keeps changing dynamically. The principle thereof is that the slice level determining device integrates the runlengths of the sliced binary data internally. Generally, the value of the space runlength is positive and that of the mark runlength is negative. The principle of “DSV (Digital SumValue) tending to be the smallest” will apply negative feedback control to the slice threshold level, so that the level thereof could ensure that the sum of all the space runlengths approaches the sum of the runlengths of all the marks. In this way, when the high frequency signal varies, the re-balance of slice threshold level occurs.

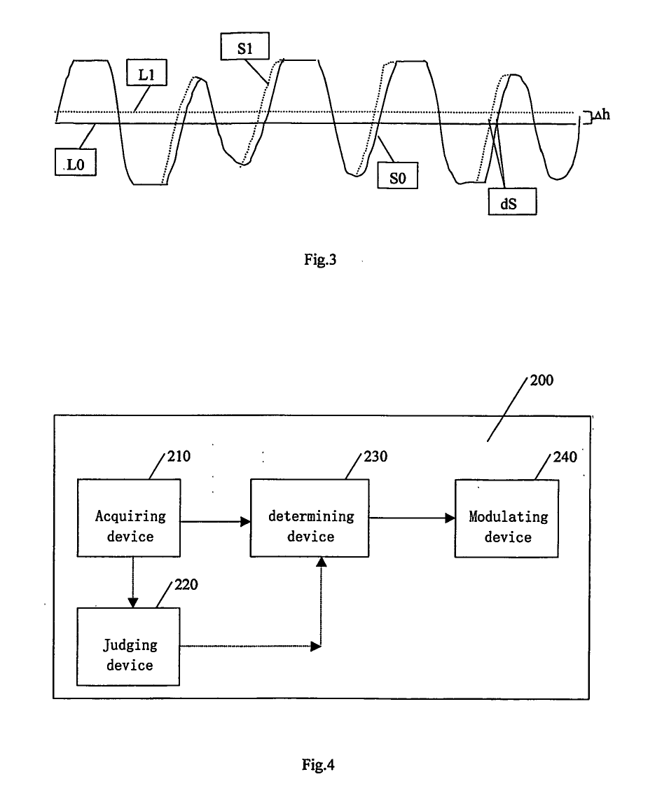

FIG. 3 shows a clearer picture of the process described above wherein said variations of high frequency signal cause the re-balance of slice level. In the figure, the solid line indicates the stable state before re-balance, and the broken line indicates the state after re-balance. S0 and S1 are respectively the high frequency signal before and after re-balance, L0 and L1 are respectively the slice threshold level before and after re-balance. dS is the variation of the read high frequency signal and Δh is the amount of the shift of the slice threshold level caused thereby. Since the high frequency signal changes from the position S0 to position S1 with the variation of dS, the slice threshold level will correspondingly move from L0 to L1 by the amount of Δh.

Thus, due to the variation (dPⱼ) of writing parameters, the physical mark lengths will vary (dPhyLⱼ) accordingly. The variations of physical mark lengths and physical space lengths will further cause the variation of high frequency signal. And owing to the variation of high frequency signal, the measured mark runlength will accordingly change (ΔmarkRLᵢ). However, the mark runlength not only relates to the high frequency signal, but also relates to the slice level which itself is affected by the high frequency signal.

This means that the variation of a certain writing parameter will not only cause the variation of the corresponding mark runlength, but will also affect runlengths of all other marks. Therefore, the measured mark runlengths variation amounts are not the real variation amounts of physical mark lengths. As a result, a measured mark runlength depends on the setting of all the writing parameters (for example, the physical length variation of 3T mark in CD system will affect the observed value of the runlength of the 6T mark).

The physical lengths or runlengths of marks or spaces mentioned in the present invention refer to the average length of a plurality of physical lengths or runlengths samples of a certain kind of marks or spaces in a test, and are used to evaluate the whole effect of the lengths, thereby the influences of thermal interference and measurement noise and the like can be eliminated.

Just because that the variation of each parameter will finally affect all the mark runlengths, and the conventional method cannot anticipate the complex influence of two or more parameters varying simultaneously on the mark runlengths, the conventional optimizing methods are limited to the optimizing of a single parameter. When the optimization of a plurality of parameters is concerned, they either become helpless or simplifying it into optimizing each of the parameters separately.

After carefully studying the influence of a plurality of parameters and mark runlengths, the present invention inventively put forward the optimizing method for optimizing a plurality of parameters simultaneously. The specific contents will be described in detail in the following embodiments.

FIG. 4 is a structural drawing of the optimizing apparatus for optical disc writing parameters according to the present invention. Said optimizing apparatus 200 comprises an acquiring device 210 for acquiring variable of the mark runlengths; a determining device 230 for determining the modulation amounts of the writing parameters; and a modulating device 240 for modulating the values of said writing parameters.

When carrying out the optimization, the acquiring device 210 acquires variable of the mark runlengths according to the mark runlengths from the runlength measuring device 160; afterwards, the determining device 230 confirms the modulation amounts of the writing parameters according to the relationship between variable of the mark runlengths and the modulation amounts of the writing parameters; finally, the modulating device 240 modulates said writing parameters according to the modulation amounts of the writing parameters determined by the determining device 230. Thereby, the mark runlengths could be optimized as prescribed.

The optical disc writing parameters optimizing apparatus could also comprises a judging device 220 for judging if optimization should be performed. Therefore, during the optimization, after the acquiring device 210 acquires variable of the mark runlengths, the judging device 220 judges to determine whether the optimization should be performed or not.

If the mark runlengths prescribed by the target of optimization have been achieved, no optimization needs to be performed by said apparatus and the writing can be performed directly by the conventional writing means. If there is a need to optimize, the determining device 230 will confirm the modulation amounts of the writing parameters, and finally, the modulating device 240 modulates said writing parameters according to the modulation amounts of the writing parameters determined by the determining device 230. In this way, the mark runlengths could reach the optimization target.

The above-mentioned apparatus is applicable to the once recordable or rewritable CD, DVD or the Blu-Ray optical disc.

All the processes of the optimizing method of the present invention could be carried out by said apparatus, so that the powers or starting and ending time of a plurality of laser pulses could be optimized simultaneously to make the mark runlengths reach the optimization target.

The optimizing method of the present invention will be described in detail in conjunction with the figures and embodiments in the following. The embodiment A of the optical disc writing parameters optimizing method of the present invention relates to optimizing a plurality of optical disc writing parameters of an ultra-speed CD-RW discs. In the optimizing process, writing is performed at 24× speed and the measurement is read at 10× speed. The optimizing process employs the random data sequence generated according to the EFM encoding rule and uses the “2T writing strategy” as shown in Table 1 to control the mark writing.

TABLE 1
the writing strategy used in embodiment A

3T mark
eeewwwww wwwwbbbb bbbcceee
4T mark
eeewwwww wbbbbbbb bbbwwwww wbbbbdde
5T mark
eeewwwww wbbbbbbb bbbbbbww wwwwwwwb bbbbffee
6T mark
eeewwwww wbbbbbbb bbbwwwww wbbbbbbb bbbwwwww wbbbggee
7T mark
eeewwwww wbbbbbbb bbbwwwww wbbbbbbb bbbbbbww wwwwwwwb
bbbhheee
8T mark
eeewwwww wbbbbbbb bbbwwwww wbbbbbbb bbbwwwww wbbbbbbb
bbbwwwww wbbbggee
9T mark
eeewwwww wbbbbbbb bbbwwwww wbbbbbbb bbbwwwww wbbbbbbb
bbbbbbww wwwwwwwb bbbhheee
10T mark
eeewwwww wbbbbbbb bbbwwwww wbbbbbbb bbbwwwww wbbbbbbb
bbbwwwww wbbbbbbb bbbwwwww wbbbggee
11T mark
eeewwwww wbbbbbbb bbbwwwww wbbbbbbb bbbwwwww wbbbbbbb
bbbwwwww wbbbbbbb bbbbbbww wwwwwwwb bbbhheee

Wherein, the letter w represents the writing power, e represents the erasing power, b represents cooling power, g and h are the predefined powers, parameter c is the power for precisely modulating the back edges of all the 3T marks, parameter d is the power for precisely modulating the back edges of all the 4T marks, and parameter f is the power for precisely modulating the back edges of all the 5T marks.

Before starting optimization, the parameters need to be optimized are determined. The marks 3T, 4T and 5T are very significant to the bit detection of electrical signal since they take 70% of the sample amount of all the marks and have higher frequencies, so the parameters that are determined to be optimized are c, d and f to make 3T, 4T and 5T marks reach precise mark run lengths.

The optimization target determined in this embodiment is the mark runlengths specified by the optical disc standard. Because the measurement is read at 10× speed, the optimization target of the 3T mark is 69.45 ns, the one of the 4T mark is 92.6 ns and the one of the 5T mark is 115.75 ns, meanwhile, the acceptable error range is set as ±0.5 ns.

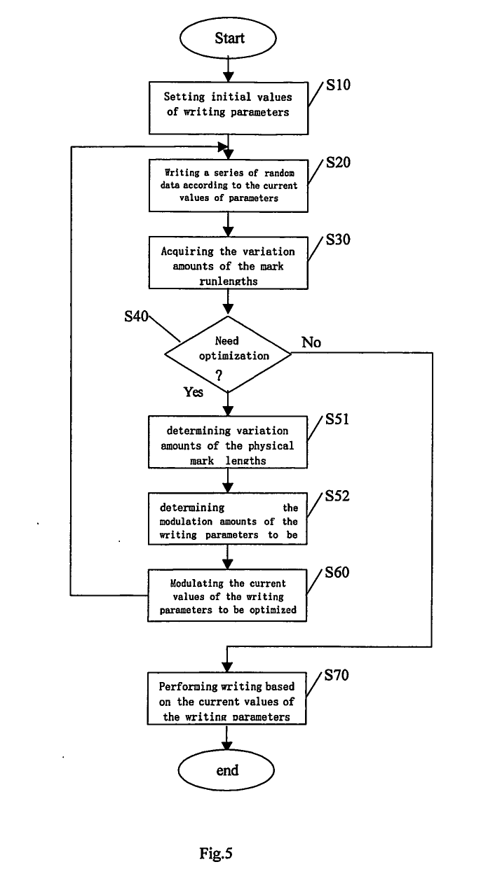

The specific optimizing process is as shown in FIG. 5. After starting optimization, step S10 is first performed to set initial value for each writing parameter.

For those parameters that will not be optimized, the parameter values thereof are predefined. According to the OPC step, the writing power Pw=40 mW, erasing power Pe=8 mW, cooling power Pb=0.1 mW, and the powers of g and h are Pg=Ph=4 mW.

Pc, Pd and Pf are the powers of the parameters c, d and f to be optimized and the initial values thereof could be set randomly within the range allowed by the driver. In order to reduce the workload of the optimizing process, they are usually set to be half of the erasing power, that is, said initial values are Pc=Pd=pf=4 mW in this embodiment.

Then, step S20 is performed to measure the mark runlengths of the written data, and the measured 3T, 4T and 5T mark runlengths are substracted respectively from the 3T, 4T and 5T mark runlengths optimization targets so as to obtain the deviation amounts of the 3T, 4T and 5T mark runlengths, which are also the desired variation amounts of the 3T, 4T and 5T mark runlengths, as indicated by the mark ♦ in FIG. 9. the variation amount of 3T mark runlength is ΔMarkRL3T=1.58 ns, the variation amount of 4T mark runlength is ΔMarkRL4T=−1.86 ns, and the variation amount of 5T mark runlength is ΔMarkRL5T=−1.15 ns. In FIG. 9, the variation amount of the mark runlength is 0 when the measured mark runlength is consistent with the optimization target of each of the mark runlengths.

Next, the judging step S40 is performed to determine whether an optimization is necessary or not. In this embodiment, the acceptable error range set in the optimizing process is ±0.5 ns, and the comparison shows that the deviation amounts of the runlengths of 3T, 4T and 5T marks all exceed the acceptable error range of the optimization target, so they should be optimized.

Then, steps S51 and S52 are performed, and the modulation amounts of the parameters to be optimized are determined according to variable of the mark lengths obtained from step S30.

Wherein, in step S51, the desired variation amounts of the physical lengths of marks 3T, 4T and 5T

$$[ \begin{matrix}dPhyLc \\ dPhyLd \\ dPhyLf\end{matrix} ] = [ \begin{matrix}2.03 & 0.73 & 0.57 \\ 1.03 & 1.73 & 0.57 \\ 1.03 & 0.73 & 1.57\end{matrix} ] \cdot [ \begin{matrix}1.58 \\ - 1.86 \\ - 1.15\end{matrix} ] = [ \begin{matrix}1.197 \\ - 2.243 \\ - 1.533\end{matrix} ]$$

could be determined on the basis of the relationship between variable of the mark runlengths and variable of the mark physical lengths:

$$[ \begin{matrix}dPhyLc \\ dPhyLd \\ dPhyLf\end{matrix} ] = [ \begin{matrix}2.03 & 0.73 & 0.57 \\ 1.03 & 1.73 & 0.57 \\ 1.03 & 0.73 & 1.57\end{matrix} ] \cdot [ \begin{matrix}Δ MarkRL 3 T \\ Δ MarkRL 4 T \\ Δ MarkRL 5 T\end{matrix} ] \qquad Eq . ( 1 )$$

That is, dPhyLc=1.197 ns, dPhyLd=−2.243 ns and dPhyLf=−1.533 ns.

Then, step S52 is performed to determine the modulation amounts of the powers of all parameters according to the desired variation amounts of the physical lengths of marks.

On the basis of the relationship between variable of the physical mark lengths and parameters, i.e., dPᵣ=dPhyLᵣ/Kᵣ, and in combination with the coefficients Kc=−0.83(ns/mW), Kd=−1.27(ns/mW), Kf=−1.05(ns/mW), the desired power modulation amounts dPc=dPhyLc/Kc=1.197/−0.83=−1.442 mW, dPd=−2.243/−1.27=1.766 mW, and dPf=−1.533/−1.05=1.46 mW could be obtained.

After obtaining the power modulation amounts, step S60 is performed to adjust the set power value of each parameter. The power values of the parameters are adjusted such that Pc=4−1.442=2.558 mW, Pd=4+1.766=5.766 mW, and Pf=4+1.46=5.46 mW.

Afterwards, go back to step S20 to re-perform the writing test. The mark runlengths are measured to determine whether they have reached the optimization target set by the system or not. The measured 3T, 4T and 5T mark runlengths are substracted from the 3T, 4T and 5T mark runlengths optimization targets, respectively to obtain the modulation amounts of the 3T, 4T and 5T mark runlengths, and the results are as indicated by symbol ▪ in FIG. 9. In FIG. 9, symbol ♦ indicates the modulation amounts of the un-optimized mark runlengths and symbol ▪ indicates that of the once-optimized mark runlengths.

Then judging step S40 is performed and the results are ΔMarkRL3T=0.105 ns, ΔMarkRL4T=−0.05 ns, ΔMarkRL5T=−0.198 ns. It can be seen that the modulation amounts of the 3T, 4T and 5T mark runlengths are greatly reduced. The above results show that the optimization target range is satisfied after one optimization and the optimizing procedure does not need to be repeated.

After reaching the optimization target, step S70 could be carried out to perform the formal writing by using the optimized power values of the parameters.

In the above described optimizing process, the relationship between the mark runlength variation amounts and the physical mark length variation amounts in Eq. (1) adoped in step 51 is determined by the following steps.

First, the relationship between the mark runlength variation amounts and the physical mark length variation amounts is determined when a plurality of writing parameters are concerned, and the principle is as follows:

Generally speaking, there are altogether M writing parameters j that need to be optimized, they are j=1, 2, . . . M; symbol Pⱼ is used to represent the set value of j, dPⱼ is used to represent the variation amount of parameter j; the physical length variation amounts of the marks directly influenced by parameter j, which are caused respectively by dPⱼ, is ΔMarkRLᵢ(j=1, 2, . . . M); and variable of the mark runlengths sliced by the signal slicer are ΔMarkRLᵢ (i=1, 2, . . . N). Wherein, symbol i is the mark type allowed by the standard. For instance, for the CD optical disc system adopting the EFM encoding rule, i could be 3T, 4T, . . . 11T marks which are represented by symbol i=1, 2, . . . 9, respectively.

The relationship between the parameter variation amounts and variable of mark runlengths could be:

| | | | | |
|---|---|---|---|---|
| dP₁ | → | dPhyL₁ | | ΔMarkRL₁ |
| dP₂ | → | dPhyL₂ | | ΔMarkRL₂ |
| ... | | ...... | | ...... |
| dPⱼ | → | dPhyLⱼ | 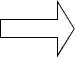 | ΔMarkRLᵢ |
| ... | ...... | | ...... | |
| dP_{M} | → | dPhyL_{M} | | ΔMarkRL_{M} |

The above process has been described in detail in conjunction with FIG. 2 in the background art. After carefully studying the reasons that cause the variations of the mark runlength, the relationship between variable of the physical mark length and variable of the mark runlengths could be obtained.

For the binary signal slicer on working, the slice threshold level will usually become stable after a short period of transition. Since the slicer has a very large time constant with respect to the high frequency signal, the slice threshold level could be considered as a constant level during a period of time. Meanwhile, the read high frequency signals usually have the same advancing edges and falling edges for all the marks and steps, and they are linear near the slice threshold level and the absolute value of the slope thereof is “K”.

Further, different sample amounts of mark i will have different influences on the variation of slice threshold level, so it is necessary to define a weight coefficient jp to describe the distribution of sample mark amounts with jp indicating the percentage of the sample amounts of the mark that is directly influenced by parameter j in the sample amounts of all the marks. Generally, when using the random data generated according to encoding rules to optimize, the distribution weight coefficient is associated with the encoding rule, and when using the data defined by the user to optimize, the distribution weight coefficient is not associated with the encoding rule.

When the slice threshold level is in the initial state of its balanced position, if the parameter j is varied by a variation amount dPⱼ, the physical length variation amount of the corresponding mark caused by dPⱼ is dPhyLⱼ, thereby, the read high frequency signal will vary. According to the principle of “DSV tending to be the smallest”, the slice threshold level will shift Δh to compensate the variation amount of the sum of the measured runlengths of all the marks after slicing, which finally makes the measured runlengths of all the marks changes by ΔMarkRLᵢ. The following equation Eq. (2) is used to indicate the result of re-balance of the slice threshold level of FIG. 3.
dPhyL₁×1p+ . . . +dPhyLⱼ×jp+ . . . +dPhyL_{M}×Mp=−(Δh/K)×2 Eq. (2)

or it could be written into a general formula of

$${\sum }_{j = 1}^{M} {dPhyL}_{j} \times jp = - ( Δ h / K ) \times 2$$

The measured variation amount of runlength of mark i could be expressed by the actual variation amount of the physical mark length and the shift of the slice threshold level with the following Eq. (3).

$$Δ {MarkRL}_{i} = ( Δ h / K ) \times 2 + {\sum }_{j = 1}^{M} {e}_{ij} \times {dPhyL}_{j} \qquad Eq . ( 3 )$$

Wherein, eᵢⱼ is the influence coefficient, and when the parameter j directly influences the mark i, eᵢⱼ=1, and when the parameter j does not directly influence mark i, eᵢⱼ=0.

By combining Eq. (2) and Eq. (3), the transformation relation in the Eq. (4) between variable of physical mark lengths and variable of mark runlengths that concerns a plurality of writing parameters could be obtained.

$$[ \begin{matrix}Δ {MarkRL}_{1} \\ Δ {MarkRL}_{2} \\ ⋮ \\ Δ {MarkRL}_{i} \\ ⋮ \\ Δ {MarkRL}_{N}\end{matrix} ] = [ \begin{matrix}{v}_{11} & {v}_{12} & {v}_{13} & ⋯ & {v}_{1 j} & ⋯ & {v}_{1 M} \\ {v}_{21} & {v}_{22} & {v}_{23} & ⋯ & {v}_{2 j} & ⋯ & {v}_{2 M} \\ ⋮ & ⋮ & ⋮ & ⋰ & ⋮ & ⋮ & ⋮ \\ {v}_{i 1} & {v}_{i 2} & {v}_{i 3} & ⋯ & {v}_{ij} & ⋯ & {v}_{iM} \\ ⋮ & ⋮ & ⋮ & … & ⋮ & ⋰ & ⋮ \\ {v}_{N 1} & {v}_{N 2} & {v}_{N 3} & … & {v}_{Nj} & ⋯ & {v}_{NM}\end{matrix} ] \cdot [ \begin{matrix}{dPhyL}_{1} \\ {dPhyL}_{2} \\ {dPhyL}_{3} \\ ⋮ \\ {dPhyL}_{j} \\ ⋮ \\ {dPhyL}_{M}\end{matrix} ] \qquad Eq . ( 4 )$$

Wherein, the coefficient of the transformation matrix is Vᵢⱼ=−jp+eᵢⱼ.

Afterwards, the above transformation relation is inversely transformed to obtain the relationship between variable of the mark runlengths and variable of the physical mark lengths. And the specific method is:

When M=N, and the transformation matrix is nonsingular mathematically, namely, the determinant of the transformation matrix does not equal to zero, it is written as

$$det [ \begin{matrix}{v}_{11} & {v}_{12} & {v}_{13} & ⋯ & {v}_{1 j} & ⋯ & {v}_{1 M} \\ {v}_{21} & {v}_{22} & {v}_{23} & ⋯ & {v}_{2 j} & ⋯ & {v}_{2 M} \\ ⋮ & ⋮ & ⋮ & ⋰ & ⋮ & ⋮ & ⋮ \\ {v}_{i 1} & {v}_{i 2} & {v}_{i 3} & ⋯ & {v}_{ij} & ⋯ & {v}_{iM} \\ ⋮ & ⋮ & ⋮ & … & ⋮ & ⋰ & ⋮ \\ {v}_{N 1} & {v}_{N 2} & {v}_{N 3} & … & {v}_{Nj} & ⋯ & {v}_{NM}\end{matrix} ] \neq 0$$

Eq. (4) is inversely transformed to obtain the relationship between variable of the mark runlengths and variable of the physical mark lengths that concerns a plurality of writing parameters, which is written as:

$$[ \begin{matrix}{dPhyL}_{1} \\ {dPhyL}_{2} \\ {dPhyL}_{3} \\ ⋮ \\ {dPhyL}_{j} \\ ⋮ \\ {dPhyL}_{M}\end{matrix} ] = {[ \begin{matrix}{v}_{11} & {v}_{12} & {v}_{13} & ⋯ & {v}_{1 j} & ⋯ & {v}_{1 M} \\ {v}_{21} & {v}_{22} & {v}_{23} & ⋯ & {v}_{2 j} & ⋯ & {v}_{2 M} \\ ⋮ & ⋮ & ⋮ & ⋰ & ⋮ & ⋮ & ⋮ \\ {v}_{i 1} & {v}_{i 2} & {v}_{i 3} & ⋯ & {v}_{ij} & ⋯ & {v}_{iM} \\ ⋮ & ⋮ & ⋮ & … & ⋮ & ⋰ & ⋮ \\ {v}_{N 1} & {v}_{N 2} & {v}_{N 3} & … & {v}_{Nj} & ⋯ & {v}_{NM}\end{matrix} ]}^{- 1} \cdot [ \begin{matrix}Δ {MarkRL}_{1} \\ Δ {MarkRL}_{2} \\ ⋮ \\ Δ {MarkRL}_{i} \\ ⋮ \\ Δ {MarkRL}_{N}\end{matrix} ] . \qquad Eq . ( 5 )$$

In the present embodiment, symbol dPc indicates the power variation amount of parameter c, dPd indicates the power variation amount of parameter d, and dPf indicates the power variation amount of parameter f. Symbol dPhyLc indicates the variation amount of the physical length of the 3T mark caused by dPc, dPhyLd indicates the variation amount of the physical lengths of the 4T marks caused by dPd and dPhyLf the variation amount of the physical lengths of the 5T marks caused by dPf. ΔMarkRL3T indicates the measured variation amount of the runlengths of the 3T marks, ΔMarkRL4T the variation amount of the runlengths of the 4T marks and ΔMarkRL5T the variation amount of the runlengths of the 5T marks.

Therefore, according to Eq. (2), the re-balance equation of the slice threshold level could be obtained as:
dPhyLc×cp+dPhyLd×dp+dPhyLf×fp=−(Δh/K)×2

According to Eq. (3), variable of the runlengths of the 3T, 4T and 5T marks as measured after slicing could be written as:
ΔMarkRL3T=(Δh/K)×2+dPhyLc
ΔMarkRL4T=(Δh/K)×2+dPhyLd
ΔMarkRL5T=(Δh/K)×2+dPhyLf

Therefore, the relationship between the physical lengths variation amounts and runlengths variation amounts of 3T, 4T, 5T marks corresponding to Eq. (4) which is related to the parameters c, d and f is:

$$[ \begin{matrix}Δ MarkRL 3 T \\ Δ MarkRL 4 T \\ Δ MarkRL 5 T\end{matrix} ] = [ \begin{matrix}- cp + 1 & - dp & - fp \\ - cp & - dp + 1 & - fp \\ - cp & - dp & - fp + 1\end{matrix} ] \cdot [ \begin{matrix}dPhyLc \\ dPhyLd \\ dPhyLf\end{matrix} ] . \qquad Eq . ( 6 )$$

The present embodiment adopts the EFM encoding rule and the distributions of the mark sample amounts in the generated random data sequence are substantially constant. The optimizing process of the present embodiment adopts a random data sequence containing 25000 marks, wherein the sample amount distributions of each kind of the marks are as shown in Table 2.

TABLE 2
the distribution of sample mark amounts according to EFM rule

| nT | 3T | 4T | 5T | 6T | 7T | 8T | 9T | 10T | 11T |
|---|---|---|---|---|---|---|---|---|---|
| N | 7660 | 5514 | 4310 | 2620 | 1758 | 1193 | 884 | 399 | 662 |
| % | 30.64 | 22.056 | 17.24 | 10.48 | 7.032 | 4.772 | 3.536 | 1.596 | 2.648 |

Therefore, three weight coefficients could be defined to describe the sample distribution of the 3T, 4T and 5T marks. cp=7660/25000=0.31 indicates the percentage of the sample amount of the 3T marks directly influenced by parameter c, dp=5514/25000=0.22 indicates the percentage of the sample amount of the 4T marks directly influenced by parameter d, and fp=4310/25000=0.17 indicates the percentage of the sample amount of the 5T marks directly influenced by parameter f. Substituting them in Eq. (6) to obtain the equation:

$$[ \begin{matrix}Δ MarkRL 3 T \\ Δ MarkRL 4 T \\ Δ MarkRL 5 T\end{matrix} ] = [ \begin{matrix}0.69 & - 0.22 & - 0.17 \\ - 0.31 & 0.78 & - 0.17 \\ - 0.31 & - 0.22 & 0.83\end{matrix} ] \cdot [ \begin{matrix}dPhyLc \\ dPhyLd \\ dPhyLf\end{matrix} ]$$

Since the determinant of the transformation matrix does not equal to zero, i.e.,

$$det [ \begin{matrix}0.69 & - 0.22 & - 0.17 \\ - 0.31 & 0.78 & - 0.17 \\ - 0.31 & - 0.22 & 0.83\end{matrix} ] \neq 0$$

the transformation relation corresponding to Eq. (5) could be obtained by matrix inverse transformation:

$$[ \begin{matrix}dPhyLc \\ dPhyLd \\ dPhyLf\end{matrix} ] = {[ \begin{matrix}0.69 & - 0.22 & - 0.17 \\ - 0.31 & 0.78 & - 0.17 \\ - 0.31 & - 0.22 & 0.83\end{matrix} ]}^{- 1} \cdot [ \begin{matrix}Δ MarkRL 3 T \\ Δ MarkRL 4 T \\ Δ MarkRL 5 T\end{matrix} ] \\ [ \begin{matrix}dPhyLc \\ dPhyLd \\ dPhyLf\end{matrix} ] = {[ \begin{matrix}2.03 & 0.73 & 0.57 \\ 1.03 & 1.73 & 0.57 \\ 1.03 & 0.73 & 1.57\end{matrix} ]}^{- 1} \cdot [ \begin{matrix}Δ MarkRL 3 T \\ Δ MarkRL 4 T \\ Δ MarkRL 5 T\end{matrix} ] \qquad Eq . ( 1 )$$

This is the relationship in Eq. (1) between variable of the mark runlengths and variable of the physical mark lengths used in step S51.

The relationship between variable of the physical mark lengths and variable of the writing parameter values as used in step S52 which is represented by dPᵣ=dPhyLᵣ/Kᵣ, and the coefficients Kc=−0.83(ns/mW), Kd=−1.27(ns/mW) and Kf=−1.05(ns/mW) are determined by the steps described in the following.

First, the relationship between a certain writing parameter r and variable of the physical mark lengths is determined.

When only parameter r varies from the set value Pᵣ by dPᵣ, wherein dPᵣ ≠0 and dPₓ=0(x=1, 2, . . . M, x≠r), except that variation amount dPhyLᵣ of the physical length of the marks that are directly influenced by parameter r does not equal to zero, physical lengths of other marks will not change, i.e., dPhyLₓ=0. If the mark that is directly influenced by parameter r is s, the variation amount of runlength thereof is ΔMarkRLₛ; and another mark that is not directly influenced by parameter r is t, the variation amount of runlength thereof is ΔMarkRLₜ.

The following equation could be obtained from Eq. (3) to describe the measured variation amounts of the mark runlength:
ΔMarkRLₛ=(Δh/K)×2+dPhyLᵣ
ΔMarkRLₜ=(Δh/K)×2
so, ΔMarkRLₛ=ΔMarkRLₜ+dPhyLᵣ
dPhyLᵣ=ΔMarkRLₛ−ΔMarkRLₜ Eq. (7)

Usually, the relationship between the variation amount of the laser pulse parameter r and the variation amount of the physical length of the mark influenced by r could be written as dPhyLᵣ=f (dPᵣ).

In order to obtain the relationship between the variation amount of a physical mark length and the variation amount of a laser pulse parameter, many times of writing experiments are performed with Pᵣ changing each time. Then, the variation amount of the mark runlength is measured to obtain the relationship between the variation amount of the mark runlength and the variation amount of the laser pulse parameter:
ΔMarkRLₛ=f₁(Pᵣ), ΔMarkRLₜ=f₂(Pᵣ).

And with Eq. (7) combined, the equation of dPhyLᵣ=ΔMarkRLₛ−ΔMarkRLₜ=f₁(Pᵣ)−f₂(Pᵣ)=f₁₋₂(Pᵣ) could be obtained.

Substitute the initial value Pᵣ_{⁰} of the laser pulse parameter in said equation to derive the relationship between the variation amount dPᵣ of the laser pulse parameter r and the variation amount dPhyLᵣ of the mark physical length:
dPhyLᵣ=f₁₋₂(Pᵣ)=f₁₋₂(Pᵣ_{⁰}+dPᵣ)=f(dPᵣ)

On the basis of the desired variation amount dPhyLᵣ of the physical mark length and the initial value Pᵣ_{⁰} of the laser pulse parameter, the desired variation amount dPᵣ of the laser pulse parameter could be calculated.

As for common optical disc writing, by reasonably defining the parameters (the power or start and end time of the laser pulse) of the writing strategy, the relationship between said parameters and variable of the physical mark lengths directly influenced thereby is approximately linear in a certain range. Therefore, it could be defined that:
ΔMarkRLₛ=K₁×dPᵣ and ΔMarkRLₛ=K₂×dPᵣ.

Accordingly, eq. (7) becomes:
dPhyLᵣ=K₁×dPᵣ−K₂×dPᵣ=(K₁−K₂)×dPᵣ=Kᵣ×dPᵣ Eq. (8)

Then, dPᵣ=dPhyLᵣ/Kᵣ can be derived by an inverse transformation. Wherein the intensity coefficient Kᵣ is used to indicate variable of the physical lengths of the marks directly influenced by r, which are caused by variable of the laser pulse parameter r, so it could be conveniently used in the calculation of optimizing.

Finally, the coefficient Kᵣ is determined.

In the present embodiment, the coefficient K_{c}, K_{d}, K_{f} (ns/mW) of each writing parameter, namely, variable of the physical lengths of 3T, 4T, 5T marks caused by variable of the laser pulse parameters of the back edge of the 3T, 4T, 5T marks, need to be determined.

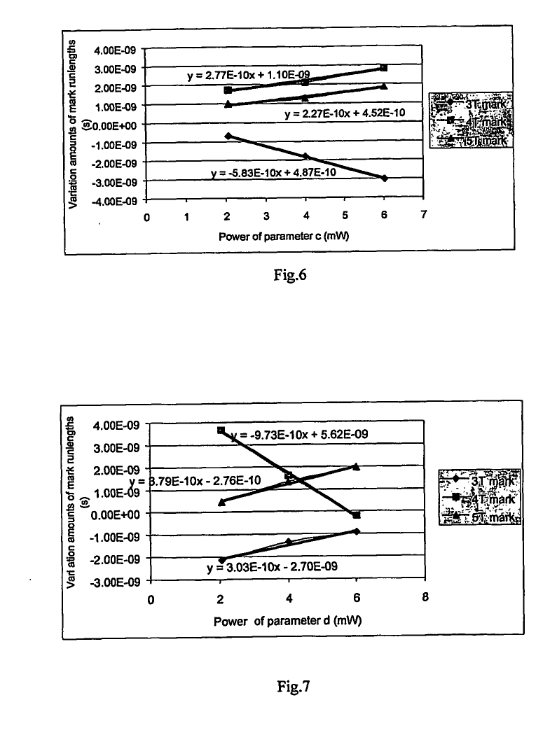

Therefore a series of writing experiments are conducted according to the initial values of each parameter determined in step S10 with c, d and f changing each time. Then, variable of the runlengths of the 3T, 4T and 5T marks with respect to the optimization target are measured, and the obtained measuring results are as shown in FIGS. 6, 7 and 8 with their linear trendlines fitted. Subsequently, the intensity coefficients of the parameters are calculated based on the slopes of the linear trendlines.

In FIG. 6 of the result of the measurement with respect to parameter c, since variable of the mark runlengths of 4T and 5T are the same with respect to parameter c, the average of the slopes thereof is taken as K₂ to eliminate measurement error.

Thus K₁=−0.58 (ns/mW) and K₂=−0.25 (ns/mW) are obtained.

According to Eq. (8), Kc=K₁−K₂=−0.58 −0.25=−0.83(ns/mW).

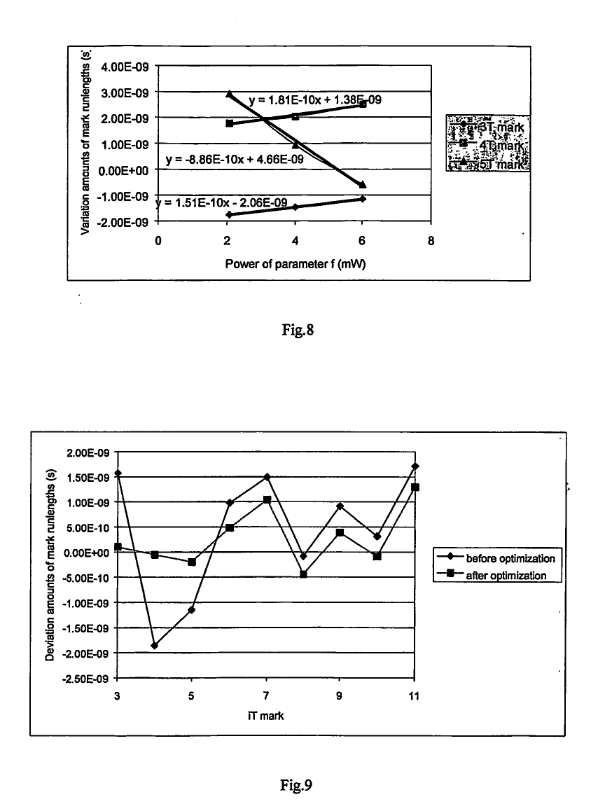

Similarly, it could be obtained from FIGS. 7 and 8 that Kd=−1.27(ns/mW), kf=−1.05(ns/mW).

Therefore, the relationship dPᵣ=dPhyLᵣ/Kᵣ between the variation amount of the physical mark length and the variation amount of the writing parameter as well as the intensity coefficients Kc=−0.83 (ns/mW), Kd=−1.27 (ns/mW), kf=−1.05 (ns/mW) are obtained.

Furthermore, the present invention is not limited to the above-described embodiment, and it could have many variations.

Such thought of simultaneously optimizing a plurality parameters could be applied to the once recordable or rewritable CD, DVD and the Blu-Ray optical disc systems, e.g., DVD+R and DVD+RW writing systems or BD-RW writing system, etc.

The applicable writing strategy could be square laser writing strategy, “dog-bone” writing strategy, “1T writing strategy” or “2T writing strategy” and the like.

The writing parameters to be optimized could not only be the laser pulse power, but also be the starting and ending time of the laser pulse. That is, it is also possible to precisely adjust the front edge and back edge of the marks to make the mark runlengths reach the optimization targets by keeping the laser pulse powers of a writing strategy unchanged while optimizing the starting and ending time of the laser pulses thereof.

Several varied embodiments of the present invention are introduced briefly in the following text so as to illustrate that the present invention is applicable to the optimization of the writing parameters under various circumstances. Wherein, the same as that of the embodiment A or the variation that is obvious will not be elaborated any more.

The embodiment B of the optimizing method of the present invention relates to optimizing a plurality of parameters of optical disc writing on the same optical disc as used in embodiment A. The difference lies in that it uses the “2T writing strategy” as shown in Table 3 to control the writing of marks.

TABLE 3
writing strategy used in embodiment B

3T mark
eeewwwww wwwwbbbb bbbcceee
4T mark
eeewwwww wbbbbbbb bbbwwwww wbbbbdde
5T mark
eeewwwww wbbbbbbb bbbbbbww wwwwwwwb bbbbffee
6T mark
eeewwwww wbbbbbbb bbbwwwww wbbbbbbb bbbwwwww wbbbggee
7T mark
eeewwwww wbbbbbbb bbbwwwww wbbbbbbb bbbbbbww wwwwwwwb
bbbhheee
8T mark
eeewwwww wbbbbbbb bbbwwwww wbbbbbbb bbbwwwww wbbbbbbb
bbbwwwww wbbbhhee
9T mark
eeewwwww wbbbbbbb bbbwwwww wbbbbbbb bbbwwwww wbbbbbbb
bbbbbbww wwwwwwwb bbbhheee
10T mark
eeewwwww wbbbbbbb bbbwwwww wbbbbbbb bbbwwwww wbbbbbbb
bbbwwwww wbbbbbbb bbbwwwww wbbbhhee
11T mark
eeewwwww wbbbbbbb bbbwwwww wbbbbbbb bbbwwwww wbbbbbbb
bbbwwwww wbbbbbbb bbbbbbww wwwwwwwb bbbhheee

Wherein, the letter w represents the writing power, e represents the erasing power, b represents cooling power, h is the predefined powers, parameter c is the power for precisely modulating the back edge of all the 3T marks, parameter d is the power for precisely modulating the back edge of all the 4T marks, parameter f is the power for precisely modulating the back edge of all the 5T marks, and parameter g is the power for precisely modulating the back edge of all the 6T marks.

Wherein, the parameters to be optimized are c, d, f and g, and they are respectively used to precisely adjust the back edges of all the 3T, 4T, 5T and 6T marks to make them reach the precise mark runlengths.

Therefore, according to the distribution of mark sample amount by the EFM encoding rule as shown in Table 2, four weight coefficients could be defined to describe the sample distribution of the 3T, 4T, 5T and 6T marks. cp=0.31 indicates the percentage of the sample amount of the 3T mark directly influenced by parameter c, dp=0.22 indicates the percentage of the sample amount of the 4T mark directly influenced by parameter d, fp=0.17 indicates the percentage of the sample amount of the 5T mark directly influenced by parameter f, and gp=0.10 indicates the percentage of the sample amount of the 6T mark directly influenced by parameter g.

Therefore, the transformation relation between variable of the mark runlengths and variable of the physical mark lengths corresponding to the expression Eq. (1) is:

$$[ \begin{matrix}dPhyLc \\ dPhyLd \\ dPhyLf \\ dPhyLg\end{matrix} ] = {[ \begin{matrix}0.69 & - 0.22 & - 0.17 & - 0.10 \\ - 0.31 & 0.78 & - 0.17 & - 0.10 \\ - 0.31 & - 0.22 & 0.83 & - 0.10 \\ - 0.31 & - 0.22 & - 0.17 & 0.90\end{matrix} ]}^{- 1} \cdot [ \begin{matrix}Δ MarkRL 3 T \\ Δ MarkRL 4 T \\ Δ MarkRL 5 T \\ Δ MarkRL 6 T\end{matrix} ] \qquad Eq . ( 9 )$$

Parameters c, d, f and g could be optimized simultaneously by using the method same as that used in embodiment A, and this will not be described in detail herein any more.

Further, the weight coefficients of the marks that are directly influenced by a certain parameter are not limited to being generated according to the encoding rule but could be defined by the user, and in this way, the weight coefficients of distribution are not associated with the encoding rule.

Embodiment C of the optimizing method of the present invention employs the same multi-parameter optimizing as embodiment B.

Embodiment C allows the user to freely define the data used for the optimization experiment, so the four weight coefficients that describe the sample distribution of the 3T, 4T, 5T and 6T marks are cp=0.3, dp=0.2, fp=0.1, gp=0.05, and each of them indicates the percentage of the sample amounts of the marks that are directly influenced by parameters c, d, f and g.

Hence, the transformation relation corresponding to the variation amount of the mark runlength and the variation amount of the physical mark length as expressed by Eq. (9) is:

$$[ \begin{matrix}dPhyLc \\ dPhyLd \\ dPhyLf \\ dPhyLg\end{matrix} ] = {[ \begin{matrix}0.7 & - 0.2 & - 0.1 & - 0.05 \\ - 0.3 & 0.8 & - 0.1 & - 0.05 \\ - 0.3 & - 0.2 & 0.9 & - 0.05 \\ - 0.3 & - 0.2 & - 0.1 & 0.95\end{matrix} ]}^{- 1} \cdot [ \begin{matrix}Δ MarkRL 3 T \\ Δ MarkRL 4 T \\ Δ MarkRL 5 T \\ Δ MarkRL 6 T\end{matrix} ] \qquad Eq . ( 10 )$$

The same method could be used to simultaneously optimize parameters c, d, f and g.

The embodiment D of the optimizing method of the present invention relates to optimizing a plurality of parameters of optical disc writing on the same optical disc as used in embodiment A, and it uses the “2T writing strategy” as shown in Table 4 to control the writing of marks.

TABLE 4
writing strategy used in embodiment D

3T mark
eeeww wwww bbbbe
www bbbb eee
4T mark
eeeww wbbbb bbbww wbbbb
www bbb www bee
5T mark
eeeww wbbbb bbbbb wwww bbbbb
www bbb bww wwwb eee
6T mark
eeeww wbbbb bbbww wbbbb bbbww wbbbg
www bbb www bbb www gee
7T mark
eeeww wbbbb bbbww wbbbb bbbbb wwww bbbhh
www bbb www bbb bww wwwb eee
8T mark
eeeww wbbbb bbbww wbbbb bbbww wbbbb bbbww wbbbh
www bbb www bbb www bbb www hee
9T mark
eeeww wbbbb bbbww wbbbb bbbww wbbbb bbbbb wwww bbbhh
www bbb www bbb www bbb bww wwwb eee
10T mark
eeeww wbbbb bbbww wbbbb bbbww wbbbb bbbww wbbbb bbbww
wbbbhh www bbb www bbb www bbb www bbb www ee
11T mark
eeeww wbbbb bbbww wbbbb bbbww wbbbb bbbww wbbbb bbbbb
wwwww bbbhh www bbb www bbb www bbb www bbb bww wwb eee

Wherein, letters w, e, b, g and h have the same definitions as in embodiment A. And the difference is that parameter c is defined to be the starting time for controlling the erasing power e of the back edge of 3T mark and is used for precisely modulating the back edges of all the 3T marks; parameter d is defined to be the starting time for controlling the erasing power e of the back edge of 4T mark and is used for precisely modulating the back edges of all the 4T marks; parameter f is defined to be the starting time for controlling the erasing power e of the back edge of 5T mark and is used for precisely modulating the back edges of all the 5T marks.

The initial value of the parameters c, d and f that are to be optimized is the time shown in Table 4, that is, 4 time divisions, 2 time divisions and 3 time divisions from the end respectively with 1 time division being 1.206 ns.

Therefore, the same transformation relation of variable of the mark runlengths and variable of the physical mark lengths as expressed by Eq. (1) could be used:

$$[ \begin{matrix}dPhyLc \\ dPhyLd \\ dPhyLf\end{matrix} ] = [ \begin{matrix}2.03 & 0.73 & 0.57 \\ 1.03 & 1.73 & 0.57 \\ 1.03 & 0.73 & 1.57\end{matrix} ] \cdot [ \begin{matrix}Δ MarkRL 3 T \\ Δ MarkRL 4 T \\ Δ MarkRL 5 T\end{matrix} ]$$

However, in step 52 the relationship between the physical length variation amounts of the writing marks and the parameter value variation amount need to be re-determined, i.e., the intensity coefficient (ns/ns) of a certain writing parameter. In other words, it is necessary to re-determine the variation amount (ns) of the physical mark length caused by the variation amount (ns) of the starting and ending time of said parameter wherein the mark is directly influenced thereby. They could also be obtained through experiments.

Therefore, according to the method used in embodiment A, it is obvious to simultaneously optimize the duration (i.e., the pulse widths) of a plurality of laser pulses.

Embodiment E of the optimizing method of the present invention is applicable to the rewritable DVD system using EFM+ encoding rule.

For once recordable or rewritable DVD optical disc system, if the random data sequence generated according to EFM+ encoding rule is used to perform the optimizing process, it shall be noted that a runlength of every two 14T is inserted at a fixed distance manually, and the distribution of the sample amount of other marks are substantially constant. So, as shown in Table 5, the weight coefficients should be correspondingly changed.

TABLE 5
the distribution of mark sample amounts according to EFM+ rule

| nT | 3T | 4T | 5T | 6T | 7T | 8T | 9T | 10T | 11T |
|---|---|---|---|---|---|---|---|---|---|
| % | 31.74 | 21.65 | 14.77 | 10.07 | 6.87 | 4.69 | 3.2 | 2.18 | 1.49 |

It is obvious that the method used in embodiment A could be used for optimizing a plurality of parameters for writing on DVD.

Further, the present invention is also applicable to the method of optimizing a part of a certain kind of marks.

The embodiment F of the optimizing method of the present invention relates to optimizing a plurality of parameters of optical disc writing on the same optical disc as used in embodiment A. But the difference lies in that it uses the “2T writing strategy” as shown in Table 6 to control the writing of marks.

TABLE 6
the basic parts of the writing strategy used in embodiment F

3T mark
eeeww wwww bbbbe
www bbbb eee
4T mark
eeeww wbbbb bbbww wbbbb
www bbb www bee
5T mark
eeeww wbbbb bbbbb wwww bbbbb
www bbb bww wwwb eee
6T mark
eeeww wbbbb bbbww wbbbb bbbww wbbbe
www bbb www bbb www eee
7T mark
eeeww wbbbb bbbww wbbbb bbbbb wwww bbbee
www bbb www bbb bww wwwb eee
8T mark
eeeww wbbbb bbbww wbbbb bbbww wbbbb bbbww wbbbe
www bbb www bbb www bbb www eee
9T mark
eeeww wbbbb bbbww wbbbb bbbww wbbbb bbbbb wwww bbbee
www bbb www bbb www bbb bww wwwb eee
10T mark
eeeww wbbbb bbbww wbbbb bbbww wbbbb bbbww wbbbb bbbww
wbbbee www bbb www bbb www bbb www bbb www ee
11T mark
eeeww wbbbb bbbww wbbbb bbbww wbbbb bbbww wbbbb bbbbb
wwwww bbbee www bbb www bbb www bbb www bbb bww wwb eee

Particularly, the laser pulse patterns as shown in Table 7 is used to control the writing of 3T, 4T and 5T marks that are adjacent to the 3T space.

TABLE 7
the special parts of the writing strategy used in embodiment F

(3T space)3T mark
eeeww wwww bbbcce
www bbbb ee
(3T space)4T mark
eeeww Wbbbb bbbww wbbbb
www bbb www dde
(3T space)5T mark
eeeww wbbbb bbbbb wwww bbbbff
www bbb bww wwwb ee

In Tables 6 and 7, the letter w represents the writing power, e represents the erasing power, b represents cooling power, parameter c is the power for precisely modulating the back edges of 3T marks which are adjacent to the 3T space, parameter d is the power for precisely modulating the back edges of 4T marks which are adjacent to the 3T space, parameter f is the power for precisely modulating the back edges of 5T marks which are adjacent to the 3T space.

Wherein, the parameters to be optimized are c, d, and f, and they are respectively used to precisely adjust the back edges of all the 3T, 4T, 5T marks which are adjacent to the 3T space to make them reach the precise mark runlengths.

Therefore, according to the distribution of the mark sample amounts by EFM encoding rule as shown in Table 2, three weight coefficients could be defined to describe the sample distribution of the 3T, 4T, and 5T marks. cp=0.31×0.31=0.096 indicates the percentage of the sample amount of the 3T mark directly influenced by parameter c, dp=0.31×0.22=0.068 indicates the percentage of the sample amount of the 4T mark directly influenced by parameter d, fp=0.31×0.17=0.053 indicates the percentage of the sample amount of the 5T mark directly influenced by parameter f.

Therefore, the transformation relation corresponding to the variation amount of the mark runlength and the variation amount of the physical mark length as expressed by Eq. (1) is:

$$[ \begin{matrix}dPhyLc \\ dPhyLd \\ dPhyLf\end{matrix} ] = {[ \begin{matrix}0.904 & - 0.068 & - 0.053 \\ - 0.096 & 0.932 & - 0.053 \\ - 0.096 & - 0.068 & 0.947\end{matrix} ]}^{- 1} \cdot [ \begin{matrix}Δ MarkRL ( 3 T ) 3 T \\ Δ MarkRL ( 3 T ) 4 T \\ Δ MarkRL ( 3 T ) 5 T\end{matrix} ] \qquad Eq . ( 11 )$$

By using the same method as that used in embodiment A, parameters c, d and f could be optimized simultaneously, thereby the 3T, 4T and 5T marks that are adjacent to the 3T space can be particularly controlled.

The embodiment G of the optimizing method of the present invention relates to optimizing a plurality of parameters of optical disc writing on the same optical disc as used in embodiment F, and it uses the “2T writing strategy” as shown in Table 6 to control the writing of marks.

However, the difference is that it uses the laser pulse pattern as shown in Table 8 to control the writing of the 3T marks which are adjacent to the 3T space, the writing of the 4T marks which are adjacent to the 4T space and the writing of the 5T marks which are adjacent to the 5T space instead of controlling the back edges of the 3T, 4T and 5T marks which are adjacent to the 3T space as shown in Table 7.

TABLE 8
the special parts of the writing strategy used in embodiment G

(3T space) 3T mark
eeewwwww wwwwbbbb bbbcceee
(4T space) 4T mark
eeewwwww wbbbbbbb bbbwwwww wbbbbdde
(5T space) 5T mark
eeewwwww wbbbbbbb bbbbbbww wwwwwwwb bbbbffee

In Table 8, the letter w represents the writing power, e represents the erasing power, b represents cooling power, parameter c is the power for precisely modulating the back edge of the 3T mark which is adjacent to the 3T space, parameter d is the power for precisely modulating the back edge of the 4T mark which is adjacent to the 4T space, parameter f is the power for precisely modulating the back edge of the 5T mark which is adjacent to the 5T space.

Wherein, the parameters to be optimized are c, d, and f, and they are respectively used to precisely adjust the back edges of the 3T mark adjacent to the 3T space, the 4T mark adjacent to the 4T space, and the 5T mark adjacent to the 5T space to make them reach the precise mark runlengths.

Therefore, according to the distribution of mark sample amounts by EFM encoding rule as shown in Table 2, three weight coefficients could be defined to describe the sample distribution of the 3T, 4T, and 5T marks. cp=0.31×0.31=0.096 indicates the percentage of the sample amount of the 3T mark directly influenced by parameter c, dp=0.22×0.22=0.048 indicates the percentage of the sample amount of the 4T mark directly influenced by parameter d, fp=0.17×0.17=0.029 indicates the percentage of the sample amount of the 5T mark directly influenced by parameter f.

Therefore, the transformation relation corresponding to the variation amount of the mark runlength and the variation amount of the physical mark length as expressed by Eq. (11) is:

$$[ \begin{matrix}dPhyLc \\ dPhyLd \\ dPhyLf\end{matrix} ] = {[ \begin{matrix}0.904 & - 0.048 & - 0.029 \\ - 0.096 & 0.952 & - 0.029 \\ - 0.096 & - 0.048 & 0.971\end{matrix} ]}^{- 1} \cdot [ \begin{matrix}Δ MarkRL ( 3 T ) 3 T \\ Δ MarkRL ( 4 T ) 4 T \\ Δ MarkRL ( 5 T ) 5 T\end{matrix} ] \qquad Eq . ( 12 )$$

By using the same method as used in embodiment A, parameters c, d and f could be optimized simultaneously, the writing of 3T mark adjacent to the 3T space, the writing of the 4T mark adjacent to the 4T space and the writing of the 5T mark adjacent to the 5T space can be particularly controlled.

A plurality of embodiments of the present invention are described in the above with reference to the figures, and these embodiments and figures are only for the purpose of illustrating the spirit, content and application of the present invention. For those skilled in the art, it is obvious to make various variations and modifications on the basis of the above descriptions, so such variations and modifications should be within the spirit and scope of the present invention. The protection scope of the present invention is defined by the claims.

1. An optical disc-writing parameters optimizing system, comprising:
an acquiring device for acquiring the variation amounts of the mark runlengths;
a confirming device for confirming the modulation amounts of the writing parameters; and
a modulating device for modulating the values of said writing parameters.

2. The device according to claim 1, further comprising a judging device for judging whether it is necessary to optimize.

3. A method for optimizing the optical disc-writing parameters, comprising the following steps:
a) acquiring the variation amounts of the mark runlengths;
b) confirming the modulation amounts of the writing parameters based on the relationship between the variation amounts of the mark runlengths and the modulation amounts of the writing parameters; and
c) modulating said parameters.
d)

4. The method according to claim 3, wherein the step (b) further comprising:
(b1) confirming the variation amounts of the physical mark lengths based on the relationship between the variation amounts of the mark runlengths and the variation amounts of the physical mark lengths;
(b2) confirming the modulation amounts of the writing parameters based on the relationship between the variation amounts of the physical mark lengths and the modulation amounts of the writing parameters.

5. The method according to claim 4, wherein the relationship between the variation amounts of the mark runlengths and the variation amounts of the physical mark lengths in step (b1), comprising:
the influence relationship of the variation amounts of the physical mark lengths on the variation amounts of the mark runlengths.

6. The method according to claim 5, wherein the influence relationship between the variation amounts of the physical mark lengths on the variation amounts of the mark runlengths comprising:
the relationships between the variation amounts of the physical mark lengths and the variation amounts of the mark runlengths, as well as the characterization amounts of the influence degrees of the variation amounts of the physical mark lengths on the variation amounts of the mark runlengths.

7. The method according to claim 6, wherein said characterization amounts of the influence degrees including:
the influence coefficients of the variation amounts of the physical mark lengths on the variation amounts of the mark runlengths.

8. The method according to claim 3, wherein said writing parameters include a plurality of writing parameters.

9. The method according to claim 7, wherein the relationship between the variation amounts of the mark runlengths and the variation amounts of the physical mark lengths includes the following formula:
$$[ \begin{matrix}{dPhyL}_{1} \\ {dPhyL}_{2} \\ {dPhyL}_{3} \\ ⋮ \\ {dPhyL}_{j} \\ ⋮ \\ {dPhyL}_{M}\end{matrix} ] = {[ \begin{matrix}{v}_{11} & {v}_{12} & {v}_{13} & ⋯ & {v}_{1 j} & ⋯ & {v}_{1 M} \\ {v}_{21} & {v}_{22} & {v}_{23} & ⋯ & {v}_{2 j} & ⋯ & {v}_{2 M} \\ ⋮ & ⋮ & ⋮ & ⋰ & ⋮ & ⋮ & ⋮ \\ {v}_{i 1} & {v}_{i 2} & {v}_{i 3} & ⋯ & {v}_{ij} & ⋯ & {v}_{iM} \\ ⋮ & ⋮ & ⋮ & ⋯ & ⋮ & ⋰ & ⋮ \\ {v}_{N 1} & {v}_{N 2} & {v}_{N 3} & ⋯ & {v}_{Nj} & ⋯ & {v}_{NM}\end{matrix} ]}^{- 1} \cdot [ \begin{matrix}Δ {MarkRL}_{1} \\ Δ {MarkRL}_{2} \\ ⋮ \\ Δ {MarkRL}_{i} \\ ⋮ \\ Δ {MarkRL}_{N}\end{matrix} ]$$
wherein the writing parameters which need optimization are j=1, 2, . . . M□
dPhyLⱼ represents the variation amount of the physical length of the mark, which is directly influenced by the j^{th} writing parameter which needs optimization.
ΔmarkRLi represents the measured i^{th} variation amount of the mark runlength;
in the transformation matrix, the coefficient νᵢⱼ is the influence coefficient, which represents the influence of parameter j on mark i, νᵢⱼ=−jp+1 when parameter j influences mark i directly; νᵢⱼ=−jp+1 when parameter j does not influence mark i directly;
jp represents the percentage of the numbers of the mark samples influenced directly by the j^{th} writing parameter which needs optimization in the whole mark samples.

10. The method according to claim 9, wherein the determinant of said transformation matrix of the influence coefficients doesn't equal zero, which is written as:
$$det [ \begin{matrix}{v}_{11} & {v}_{12} & {v}_{13} & ⋯ & {v}_{1 j} & ⋯ & {v}_{1 M} \\ {v}_{21} & {v}_{22} & {v}_{23} & ⋯ & {v}_{2 j} & ⋯ & {v}_{2 M} \\ ⋮ & ⋮ & ⋮ & ⋰ & ⋮ & ⋮ & ⋮ \\ {v}_{i 1} & {v}_{i 2} & {v}_{i 3} & ⋯ & {v}_{ij} & ⋯ & {v}_{iM} \\ ⋮ & ⋮ & ⋮ & ⋯ & ⋮ & ⋰ & ⋮ \\ {v}_{N 1} & {v}_{N 2} & {v}_{N 3} & ⋯ & {v}_{Nj} & ⋯ & {v}_{NM}\end{matrix} ] \neq 0$$

11. The method according to claim 4, wherein the step (b2) comprising the following steps:
(b2.1) doing writing experiments with a plurality of the parameter values (Pr) in order to optimize the writing parameter (r);
(b2.2) measuring the variation amount ΔMarkRLs of the length of the mark (s)'s movement, which is influenced directly by the writing parameter (r), to acquire the function relationship ΔMarkRLs=f1(Pr) between ΔMarkRLs and the parameter value (Pr);
(b2.3) measuring the variation amount ΔmarkRLt of the length of the mark (t)'s movement, which is not influenced directly by the writing parameter (r), to acquire the function relationship ΔmarkRLt=f2(Pᵣ) between ΔmarkRLt and the parameter value (Pr);
(b2.4) subtracting the result of step (b2.3) from the result of step (b2.2), to acquire the relationship dPhyLr=ΔMarkRLs−ΔMarkRL t=f1(Pᵣ)−f2(Pr)=f1−2(Pr)=f(Pr0+dPr) between the variation amount (dPhyLr) of the physical length of the mark and the parameter value (Pr) which needs optimization (wherein Pr0 is the original value of the writing parameter(r), dPr is the variation amount of the parameter value).

12. The method according to claim 3, further comprising a step:
writing a random data on said optical disc.

13. The method according to claim 3, further comprising a step:
comparing the variation amounts of each mark runlength with the predetermined optimization aim, to confirm if the continued optimization is needed.

14. The method according to claim 13, further comprising a step:
confirming the current parameter value as the parameter value which will be written to optical disc when the continued optimization is not needed.

15. The method according to claim 3, wherein said writing parameters comprise the power of the laser pulses.

16. The method according to claim 3, wherein said writing parameters comprise the starting time and the stopping time of the laser pulses.

17. The method according to claim 3, wherein the square-shaped writing strategy, “dog frame” wave-shaped writing strategy, “1T writing strategy” or “2T writing strategy” are adopted for said optical disc-writing.
